(19) United States
(12) Patent Application Publication
(10) Pub. No.: US 2024/0383497 A1
(43) Pub. Date: Nov. 21, 2024

(54) SELECTING A RESPONSE TO A TRAFFIC SITUATION FOR DRIVING ASSISTANCE SYSTEMS AND AUTOMATED DRIVING SYSTEMS

(71) Applicant: Robert Bosch GmbH, Stuttgart (DE)

(72) Inventors: Adrien Desies, Yokohama-shi (JP); Martin Stoll, Renningen (DE)

(21) Appl. No.: 18/579,067

(22) PCT Filed: Aug. 8, 2022
(86) PCT No.: PCT/EP2022/072221

§ 371 Date: Jan. 12, 2024

(30) Foreign Application Priority Data
Sep. 23, 2021 (DE) 10 2021 210 596.3

(51) Int. Cl. B60W 60/00; B60W 40/04; B60W 50/14; G08G 1/01

(52) U.S. Cl. CPC B60W 60/001; B60W 40/04; B60W 50/14; G08G 1/0112; G08G 1/0133; B60W 2540/229; B60W 2555/00

(57) ABSTRACT

A method for controlling a driving assistance system or a system for at least partially automated driving. The method includes: providing measurement data characterizing a traffic situation; ascertaining several candidate responses to the traffic situation, wherein these responses each include controlling the driving assistance system, or the system for at least partially automated driving, or suppressing such a control; ascertaining, for each of these candidate responses, a score using a distribution of response times of a driver of the vehicle, the score indicating how dangerously the traffic situation develops after performing the respective candidate response; selecting, using these scores, one of the candidate responses as the response to be carried out; controlling the driving assistance system, or the system for at least partially automated driving, to carry out the selected response.

### FIELD

The present invention relates to driving assistance systems and systems for at least partially automated driving, which sense the traffic situation of a vehicle by means of sensors.

### BACKGROUND INFORMATION

Driving assistance systems and systems for at least partially automated driving can completely or partially relieve a human driver of a vehicle of routine tasks and/or can protect the trip against careless mistakes of the driver. For example, these systems can at least partially control the actuator system of the vehicle in place of the driver. If the system reaches its limits, the driver can be asked to take control of the vehicle again. German Patent Application No. DE 10 2014 212 596 A1describes an automated driving system which automatically determines the response time of the driver and does not ask the driver to take control until this is actually required in consideration of the ascertained response time.

### SUMMARY

In the context of the present invention, a method for controlling a driving assistance system or a system for at least partially automated driving is provided. This system can constantly intervene in the actuating elements of the vehicle. However, the system can, for example, also be a collision avoidance system which passively monitors the trip in normal operation and does not intervene until a hazardous situation is detected.

According to an example embodiment of the present invention, as part of the method, measurement data are provided, which characterize a traffic situation of the vehicle. These measurement data can, for example, be obtained by monitoring the vehicle environment by means of one or more sensors.

Several candidate responses to the traffic situation are ascertained. These responses respectively include controlling the driving assistance system, or of the system for at least partially automated driving, or suppressing such a control.

The catalog of possible responses is in this case based on the specific system to be controlled. For example, in a system for at least partially automated driving, the trajectory planning for the vehicle can be changed in such a way that a potentially hazardous traffic situation develops into a less hazardous situation. In a system that provides for more involvement by the driver, such as a collision avoidance system (e.g., front collision avoidance, FCA), an expanded catalog of candidate responses, which can in particular be graduated according to their intensity, is advantageous. The candidate responses can, for example, comprise
issuing a warning about a physical warning device noticeable by the driver of the vehicle, optionally with progressively increasing urgency and/or intensity; and/or
preparing the vehicle for a braking maneuver and/or an evasive maneuver, for example by “preloading” the brake or the servo steering; and/or
initiating a braking maneuver and/or an evasive maneuver.

However, a candidate response can, for example, also consist in taking no action and observing the further development of the traffic situation.

For each of the candidate responses, a score is ascertained using a distribution V (τ) of response times τ of a driver of the vehicle, the score indicating how dangerously the traffic situation develops after performing the respective candidate response.

Using these scores, one of the candidate responses is selected as the response to be carried out. The driving assistance system, or the system for at least partially automated driving, is controlled to carry out the selected response.

Herein, “controlling” means any communication with the driving assistance system, or with the system for at least partially automated driving, that is causal for the system carrying out the selected response. This also includes, for example, changing these values in a system that internally expects an avoidance acceleration or a maximum possible acceleration, in order to trigger a particular selected response.

It has been found that the consideration of a distribution V (τ) of response times τ of the driver has the effect that the ultimately triggered response is more likely to be appropriate for the traffic situation. This distribution V (τ) of response times τ is highly driver-specific and can in a variety of ways affect the decision as to which candidate response is most useful when. For example, in a collision avoidance system, it can be useful to first give the driver a chance to deal with the situation on their own and to not issue a warning or to not intervene in the driving dynamics of the vehicle until the driver does not take this chance. A longer response time τ of the driver can thus tend to have the effect that a warning or another intervention does not occur until later. On the other hand, a longer response time τ of the driver has the effect that, for example after a warning, the traffic situation can first escalate even longer, before the driver responds to thereto.

Since an accident must absolutely be avoided, conventional systems often assume the worst case in terms of response time τ. A comparatively low threshold is therefore used for a warning and/or intervention. This can have the consequence that the driver is already faced with a warning or an intervention in the driving dynamics before they can respond themselves. Such a behavior can be quickly perceived as irritating by the driver, with the consequence that they eventually switch off the corresponding assistance system. Furthermore, for example, braking in general can also be too severe if, at the moment when a collision avoidance system brakes, the driver also steps on the brake simultaneously.

Both driving comfort and safety are therefore improved by the additional consideration of the distribution V (τ) of response times τ. In this context, the consideration of a distribution instead of a single value takes into account the fact that response times τ are generally subject to a spread. Furthermore, from such a distribution V (τ), it can also be well estimated with which probability a response of the driver is still to be expected, assuming that a certain amount of response time has already elapsed.

In a particularly advantageous embodiment of the present invention, the score of at least one candidate response depends on a measure of a prediction of
the probability p_{c} that the driver of the vehicle has already perceived a hazard in the traffic situation and is able to avert it by themselves; and/or
the probability pᵣ that the driver of the vehicle will still perceive and avert a hazard in the traffic situation; and/or
the probability c that the vehicle will be involved in an accident based on the traffic situation and the candidate response.

For example, the probability that the driver is able to avert the situation by themselves can be based on a measure of the criticality K of the situation. One such possible measure of the criticality K, on which the score can advantageously depend, is the ratio of an avoidance acceleration of the vehicle, required to avoid an accident, in one or more directions to the maximum possible acceleration of the vehicle in this direction. This measure indicates to what extent the available intervention options must be exhausted or how much “breathing room” there still is if the traffic situation escalates further. The criticality K, just like a probability, is dimensionless so that, for example, p_{c} can be approximated as 1-K.

The probability pᵣ that the driver of the vehicle will still perceive and avert a hazard in the traffic situation can, for example, in particular depend on the distribution of V (τ) of response times τ:

$${p}_{r} = ( 1 - {p}_{c} ) \cdot ( 1 - K ( V ( τ ) ) ) .$$

In a given traffic situation, the distribution V (τ) thus decides how critical the traffic situation is. For example, K can depend on an expected value of the distribution V (τ).

The probability c that the vehicle will be involved in an accident based on the traffic situation and the candidate response can, for example, be related to p_{c} and pᵣ:

$$c = 1 - {p}_{c} - {p}_{r} .$$

In a given traffic situation, pᵣ and c can in particular depend on the candidate response. For example, if a deceleration of the vehicle is proposed as a candidate response, the traffic situation will become less critical as a result. For example, if a warning is issued to the driver, it can have the result that the driver will be more likely to respond and avert the hazard. The associated probability pᵣ, and thus the score of at least one candidate response, can thus advantageously depend on the probability that the driver responds to a warning previously issued to them. For example, pᵣ can change to

$${p}_{r}^{*} = 1 - ( 1 - {p}_{r} ) \cdot ( l \cdot K ( V ( τ ) ) + 1 - l ) ,$$

wherein, again, an expected value of the distribution can be used for V (τ), and 1 is the probability that the driver of the vehicle will respond to the previously issued warning. This probability 1 can, for example, in turn be advantageously ascertained as an integral over the distribution V (τ) of response times τ from the time elapsed since the warning was issued. The more time passes, the smaller this integral becomes. This means that the effect of the warning “dissipates” over time. Conversely, however, this means that a recent warning can inhibit the issuance of a new warning for some time.

Superfluous warnings and other interventions are thus suppressed. Instead, for each intervention, on the basis of the score, which can, for example depend on the accident probability c, a benefit-error assessment can be carried out as to the gain, assessed according to the reduction of the accident probability, that can even be expected from the respective candidate response in comparison to a non-response.

In a particularly advantageous embodiment of the present invention, the score of at least one candidate response depends on the ratio of an avoidance acceleration aₐ of the vehicle, required to avoid an accident, in one or more directions to the maximum possible acceleration aₘₐₓ of the vehicle in this direction. This ratio can, for example, in particular enter into the measure of criticality K of the traffic situation. For example, if the vehicle drives head-on toward an object, the avoidance acceleration aa can be calculated according to

$${a}_{a} = \frac{{v}_{r}^{2}}{2 \cdot d}$$

where vᵣ is the relative speed and d is the distance between the vehicle and the object. For evasive maneuvers, the avoidance acceleration also has components that do not point in the current driving direction. In the interest of better readability, the term “acceleration” is used herein in the sense of “magnitude of acceleration;” a deceleration is, of course, a negative acceleration. As explained above, the ratio of aₐ to aₘₐₓindicates to what extent the freedom of action with respect to acceleration must be exhausted. In particular, when aₘₐₓ is fully exhausted, there is no more room for any uncertainties, such as an unexpectedly poor friction coefficient of the tire-roadway contact, which diminishes aₘₐₓ.

In addition, the following can advantageously also be considered in the said ratio:
the accelerations aᵣ of the vehicle of which the driver of the vehicle is in principle capable, and/or.
the acceleration aₓ currently applied to the vehicle, in order to ultimately also make the score dependent on a_{F} and/or aₓ. For example, inexperienced drivers in particular often step too tentatively on the brake pedal, as a result of which the maximum achievable acceleration a_{F} lags behind the actually maximum possible acceleration aₘₐₓ. A part of the maximum possible acceleration aₘₐₓ can also already be exploited by an acceleration aₓ so that only a lower additional acceleration is actually still available.

The acceleration a_{F} of the vehicle of which the driver of the vehicle is capable can, for example, in particular be interpolated between a basic acceleration on the one hand and a physically maximum possible acceleration of the vehicle on the other hand. For this interpolation, the current driver behavior can in particular be used. For example, it can be ascertained how well the driver manages to meter the braking force during target braking where the vehicle is to be brought to a stop at a stop line, for example. If the driver here clearly brakes too tentatively at first, the probability is increased that the driver will also do so in a hazardous situation and will not achieve the maximum acceleration aₘₐₓ.

In a particularly advantageous embodiment of the present invention, the distribution V (τ) of the response times τ is ascertained from time differences between
determining a hazard in the traffic situation on the basis of the measurement data and/or issuing a warning to the driver of the vehicle, on the one hand, and
determining a response of the driver to the hazard or to the warning, on the other hand.

In this way, the distribution V (τ) can continuously be kept current. There are many reasons why response times τ can fluctuate. In addition to the current condition and the fatigue state of the driver, the time of day or the type of the driven route also come into consideration here, for example. Thus, for example, a long monotone highway route can be tiring and can reduce attention, as a result of which the response time tends to be prolonged.

Alternatively, or also in combination therewith, the distribution V (τ) of the response times τ can, for example, be ascertained by adapting a parameterized approach to a metrologically recorded state, and/or to a metrologically recorded behavior, of the driver of the vehicle. For example, many vehicles are already equipped with fatigue sensors that derive the fatigue state of the driver from eye movements and other vegetative signs of the driver. Thus, for example, with increasing travel time, and/or in response to the fact that a fatigue of the driver of the vehicle is metrologically determined, the distribution V (τ) of the response times τ can in particular be changed toward longer response times.

According to an example embodiment of the present invention, the method can in particular be computer-implemented completely or partially. The present invention therefore also relates to a computer program with machine-readable instructions which, when executed on one or more computers, cause the computer(s) to perform the described method. In this sense, control devices for vehicles and embedded systems for technical devices that are likewise capable of executing machine-readable instructions are also to be regarded as computers.

Likewise, the present invention also relates to a machine-readable data storage medium and/or to a download product with the computer program. A download product is a digital product that can be transmitted via a data network, i.e., can be downloaded by a user of the data network, and can, for example, be offered for immediate download in an online shop.

Furthermore, according to an example embodiment of the present invention, a computer can be equipped with the computer program, with the machine-readable data carrier, or with the download product.

Further measures improving the persent invention are described in more detail below on the basis of the figures, together with the description of the preferred exemplary embodiments of the present invention.

### BRIEF DESCRIPTION OF THE DRAWINGS

FIG. 1 shows an exemplary embodiment of a method 100 according to the present invention.

FIG. 2 shows exemplary traffic situation 51 in which the method 100 can advantageously be used.

### DETAILED DESCRIPTION OF EXAMPLE EMBODIMENTS

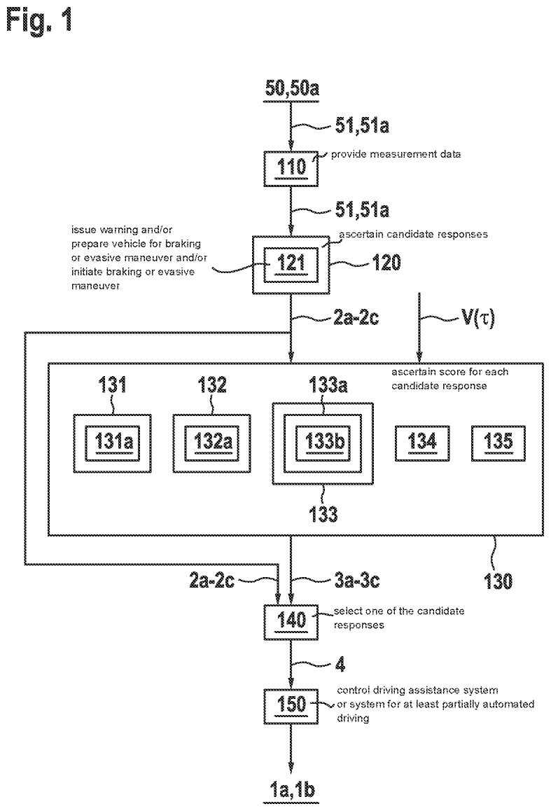

FIG. 1 is a schematic flow diagram of an exemplary embodiment of the method 100 for controlling a driving assistance system 1aor a system 1b for at least partially automated driving.

In step 110, measurement data 51a are provided, which characterize a traffic situation 51 of a vehicle 50. The measurement data can, for example, be obtained by observing the environment 50a of the vehicle 50 by means of at least one sensor.

In step 120, several candidate responses 2a-2c to the traffic situation 51 are ascertained. These responses 2a-2c each include controlling the driving assistance system 1a, or the system 1b for at least partially automated driving, or suppressing such a control.

According to block 121, these candidate responses 2a-2c can, for example, in particular comprise
issuing a warning via a physical warning device noticeable by the driver of the vehicle (50); and/or
preparing the vehicle (50) for a braking maneuver and/or an evasive maneuver; and/or
initiating a braking maneuver and/or an evasive maneuver.

In step 130, a score 3a-3c is ascertained for each candidate response 2a-2c using a distribution V (τ) of response times τ of a driver of the vehicle 50. This score 3a-3c respectively indicates how dangerously the traffic situation 51 develops after performing the respective candidate response 2a-2c.

According to block 131, this score 3a-3c can, for example, in particular depend on
the probability p_{c} that the driver of the vehicle 50 has already perceived a hazard in the traffic situation 51 and is able to avert it by themselves; and/or
the probability pᵣ that the driver of the vehicle 50 will still perceive and avert a hazard in the traffic situation; and/or
the probability c that the vehicle 50 will be involved in an accident based on the traffic situation and the candidate response.

According to block 131a, the probability that the driver of the vehicle 50 will still perceive and avert a hazard in the traffic situation can depend on the distribution V (τ) of response times τ.

According to block 132, the score 3a-3c of at least one candidate response 2a-2c can depend on the probability that the driver of the vehicle 50 responds to a warning previously issued to them. According to block 132a, this probability can be ascertained as an integral over the distribution V (τ) of response times τ from the time elapsed since the warning was issued.

According to block 133, the score 3a-3c of at least one candidate response 2a-2c depends on the ratio of an avoidance acceleration aₐ of the vehicle, required to avoid an accident, in one or more directions to the maximum possible acceleration aₘₐₓof the vehicle in this direction.

According to block 133a, the score 3a-3c can additionally depend on:
the accelerations a_{F} of the vehicle 50 of which the driver of the vehicle 50 is in principle capable, and/or the acceleration aₓ currently applied to the vehicle 50.

According to block 133b, the acceleration a_{F} of the vehicle 50 of which the driver of the vehicle 50 is capable can be interpolated between a basic acceleration on the one hand and a physically maximum possible acceleration of the vehicle 50 on the other hand.

According to block 134, the distribution V (τ) of the response times τ can be ascertained from time differences between
determining a hazard in the traffic situation 51 on the basis of the measurement data 51ₐ and/or issuing a warning to the driver of the vehicle 50, on the one hand, and determining a response of the driver to the hazard or to the warning, on the other hand.

According to block 135, the distribution V (τ) of the response times τ can be ascertained by adapting a parameterized approach to a metrologically recorded state, and/or to a metrologically recorded behavior, of the driver of the vehicle 50.

In step 140, using the scores 3a-3c, one of the candidate responses 2a-2c is selected as the response 4 to be carried out.

In step 150, the driving assistance system 1a, or the system 1b for at least partially automated driving, is controlled to carry out the selected response 4.

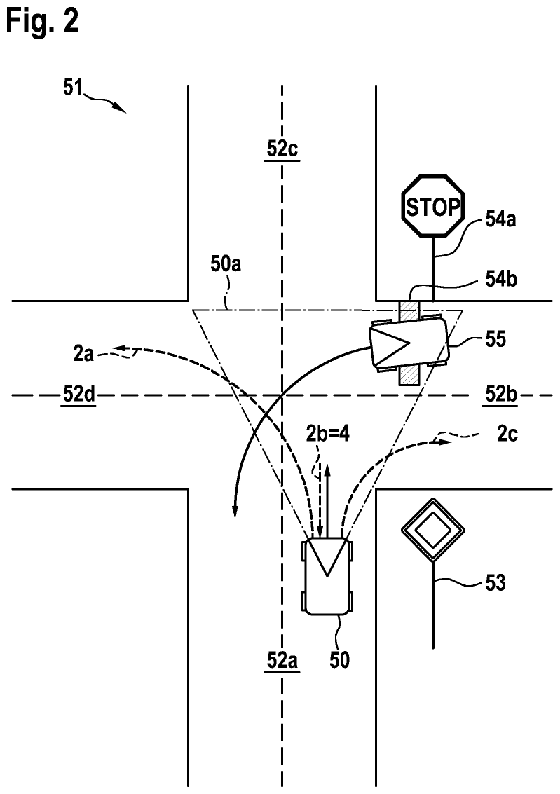

FIG. 2 schematically shows a traffic situation 51 in which the above-described method 100 can be advantageously used. A vehicle 50 equipped with a collision avoidance system as the driving assistance system 1a drives on a road 52a toward the intersection with three further roads 52b, 52c and 52d. The road 52a is a priority road marked with the traffic sign 53. Vehicles coming from the road 52b are required by a stop sign 54a and a stop line 54b to wait in front of the intersection.

In the snapshot shown in FIG. 2, the driver of a further vehicle 55 has disregarded the stop sign 54a and the stop line 54b and drives into the intersection in order to turn left into the road 52a. In so doing, this vehicle 55 enters the detection range of the vehicle 50. The vehicle 50 can thus determine that the vehicle 55 is on a collision course.

In FIG. 2, three different trajectories for the vehicle 50 are drawn as candidate responses 2a-2c, wherein the candidate response 2b corresponds to full braking. Candidate response 2a comprises accelerating and requires, as an additional contribution of the driver, that the driver steers the vehicle 50 in a wide arc toward the roadway 52d. Candidate response 2ccomprises moderate braking and requires, as an additional contribution of the driver, that the driver steers the vehicle 50 in a narrow arc toward the roadway 52b.

With an immediate and correct response of the driver, an evasive maneuver according to the candidate responses 2a and 2c would be doable in each case. However, considering the distribution V (τ) of response times τ of the driver has the result that the driver will probably respond too late to a surprising acceleration or a surprisingly only moderate braking so that either a collision with the other vehicle 55 or loss of control due to jerking of the steering wheel will occur. Full braking 2b is therefore ultimately selected as the response 4 to be carried out.

1-15. (canceled).

16. A method for controlling a driving assistance system or a system for at least partially automated driving, comprising the following steps:
providing measurement data which characterize a traffic situation of a vehicle;
ascertaining several candidate responses to the traffic situation, wherein the candidate responses each include controlling the driving assistance system, or the system for at least partially automated driving, or suppressing such a control;
ascertaining, for each of the candidate responses, a score using a distribution of response times of a driver of the vehicle, the score indicating how dangerously the traffic situation develops after performing the respective candidate response;
selecting, using the scores, one of the candidate responses as a response to be carried out; and
controlling the driving assistance system, or the system for at least partially automated driving, to carry out the selected response.

17. The method according to claim 16, wherein the candidate responses include:
issuing a warning via a physical warning device noticeable by the driver of the vehicle; and/or
preparing the vehicle for a braking maneuver and/or an evasive maneuver; and/or
initiating a braking maneuver and/or an evasive maneuver.

18. The method according to claim 16, wherein the score of at least one of the candidate responses depends on a measure of a prediction of:
a probability that the driver of the vehicle has already perceived a hazard in the traffic situation and is able to avert it by themselves; and/or
a probability that the driver of the vehicle will still perceive and avert a hazard in the traffic situation; and/or
a probability that the vehicle is involved in an accident based on the traffic situation and the candidate response.

19. The method according to claim 18, wherein the probability that the driver of the vehicle will still perceive and avert a hazard in the traffic situation depends on the distribution of response times.

20. The method according to claim 16, wherein the score of at least one of the candidate responses depends on a probability that the driver of the vehicle responds to a warning previously issued to them.

21. The method according to claim 20, wherein the probability that the driver of the vehicle responds to a warning previously issued to them is ascertained as an integral over the distribution of response times τ from the time elapsed since the warning was issued.

22. The method according to claim 16, wherein the score of at least one of the candidate responses depends on a ratio of an avoidance acceleration of the vehicle, required to avoid an accident, in one or more directions, to a maximum possible acceleration of the vehicle in the direction.

23. The method according to claim 22, wherein the score additionally depends on:
an acceleration of the vehicle of which the driver of the vehicle is in principle capable, and/or
an acceleration currently applied to the vehicle.

24. The method according to claim 23, wherein the acceleration of the vehicle of which the driver of the vehicle is capable is interpolated between a basic acceleration and a physically maximum possible acceleration of the vehicle.

25. The method according to claim 16, wherein the distribution of the response times is ascertained from time differences between:
(i) determining a hazard in the traffic situation based on the measurement data and/or issuing a warning to the driver of the vehicle, and
(ii) determining a response of the driver to the hazard or to the warning.

26. The method according to claim 16, wherein the distribution of the response times is ascertained by adapting a parameterized approach to a metrologically recorded state, and/or to a metrologically recorded behavior, of the driver of the vehicle.

27. The method according to claim 26, wherein, with increasing travel time, and/or in response to a fatigue of the driver of the vehicle being metrologically determined, the distribution of the response times is changed toward longer response times.

28. A non-transitory machine-readable data carrier on which is stored a computer program for controlling a driving assistance system or a system for at least partially automated driving, the computer program, when executed by one or more computers, causing the one or more computers to perform the following steps:
providing measurement data which characterize a traffic situation of a vehicle;
ascertaining several candidate responses to the traffic situation, wherein the candidate responses each include controlling the driving assistance system, or the system for at least partially automated driving, or suppressing such a control;
ascertaining, for each of the candidate responses, a score using a distribution of response times of a driver of the vehicle, the score indicating how dangerously the traffic situation develops after performing the respective candidate response;
selecting, using the scores, one of the candidate responses as a response to be carried out; and
controlling the driving assistance system, or the system for at least partially automated driving, to carry out the selected response.

29. One or more computers configured to control a driving assistance system or a system for at least partially automated driving, the one or more computers being configured to:
provide measurement data which characterize a traffic situation of a vehicle;
ascertain several candidate responses to the traffic situation, wherein the candidate responses each include controlling the driving assistance system, or the system for at least partially automated driving, or suppressing such a control;
ascertain, for each of the candidate responses, a score using a distribution of response times of a driver of the vehicle, the score indicating how dangerously the traffic situation develops after performing the respective candidate response;
select, using the scores, one of the candidate responses as a response to be carried out; and
control the driving assistance system, or the system for at least partially automated driving, to carry out the selected response.
